(19) United States
(12) Patent Application Publication
(10) Pub. No.: US 2014/0332729 A1
(43) Pub. Date: Nov. 13, 2014

(54) PROCESS FOR ENCAPSULATING AN INORGANIC PIGMENT BY POLYMERIZATION IN AN ORGANIC MEDIUM

(71) Applicants: ARKEMA FRANCE, Colombes (FR); INSTITUT POLYTECHNIQUE BORDEAUX, Talence Cedex (FR); UNIVERSITE DE BORDEAUX 1, Talence Cedex (FR); CENTRE NATIONAL DE LA RECHERCHE SCIENTIFIQUE, Paris Cedex 14 (FR)

(72) Inventors: Cyril Brochon, Merignac (FR); Georges Hadziioannou, Leognan (FR); Antoine Charbonnier, Bordeaux (FR)

(73) Assignees: ARKEMA FRANCE, Colombes (FR); INSTITUT POLYTECHNIQUE DE BORDEAUX, Talence Cedex (FR); UNIVERSITE DE BORDEAUX 1, Talence Cedex (FR); CENTRE NATIONAL DE LA RECHERCHE SCIENTIFIQUE, Paris Cedex 14 (FR)

(21) Appl. No.: 14/350,972

(22) PCT Filed: Oct. 9, 2012
(86) PCT No.: PCT/FR2012/052283

§ 371 Date: May 28, 2014

(30) Foreign Application Priority Data
Oct. 10, 2011 (FR) 11 59108

(51) Int. Cl. G02F 1/167; C09C 3/10

(52) U.S. Cl. CPC G02F 1/167; C09C 3/10; G02F 2001/1678
USPC 252/500; 523/333; 523/200; 523/300

(57) ABSTRACT

The present invention relates to the field of inks for electrophoretic display devices, and more particularly to a process for encapsulating at least one inorganic pigment by dispersion polymerization in an organic medium. The process consists in dispersing the inorganic pigment in the organic medium, then in synthesizing at least one stable polymer latex in said organic medium, said latex precipitating around said inorganic pigment in order to form a protective shell and to thus obtain a particle, said synthesis of the latex being carried out by polymerization, in said organic medium, of an electrostatically chargeable functional monomer, based on use of a macroinitiator capable of stabilizing said particle obtained.

The present invention relates to the field of inks for electrophoretic display devices, and more particularly to the encapsulation, in an organic medium, of inorganic pigments by positively or negatively chargeable polymers.

More specifically, the invention relates to a process for encapsulating an inorganic pigment by dispersion polymerization in an organic medium, to the use of such a process for manufacturing an electrophoretic ink, and to an electrophoretic ink produced from using such a process.

There are currently essentially two modes of information display. There are, on the one hand, electronic displays of liquid crystal LCD (acronym for “Liquid Crystal Display”) type or plasma type for example, and, on the other hand, displays by printing on a paper support. Electronic displays have a big advantage since they are capable of rapidly updating displayed information and therefore of changing contents, they are also said to be rewritable. This type of display is, however, complex to produce since the manufacturing thereof requires working in a clean room and high-tech electronics. It is consequently relatively expensive. Displays made by printing on a paper support, for their part, can be produced in bulk since they are very inexpensive, but do not allow information to be rewritten over the previous information. This type of display belongs to non-rewritable displays.

The idea of being able to combine the advantages of the two technologies arose a few years ago. A flexible display which can be manufactured at low cost and in great volume was produced. This display is the analog of paper but in an electronic version, i.e. the information displayed on this support can be erased so as to rapidly leave room for another content. Furthermore, unlike the existing screens which need to always have a power supply in order to be able to operate, electronic paper consumes only a very small amount of energy, only at the time the display changes. At a time when energy consumption is a major problem, having a flexible, reusable display device which mimics paper and consumes virtually no energy is a great opportunity. Furthermore, electronic paper is a reflective device, hence a much increased reading comfort compared with screens with back-lighting which considerably tire the eyes. This type of display is based on EPIDS (acronymon for “ElectroPhoretic Image DisplayS”) technology. This technology consists in dispersing charged particles in a nonconductive medium between two parallel electrodes. More specifically, the display comprises a conductive surface electrode, a cavity comprising pixels filled with electrophoreticink, and a bottom electrode connected to transistors, each transistor making it possible to control a pixel. The pixels can be produced in various ways. They can, for example, be produced by means of a grid which partitions the cavity into as many pixels as are necessary for producing the display, or else they can be in the form of microcapsules, each microcapsule defining a pixel and being filled with said ink. The electrophoretic ink comprises generally white, negatively charged nanoparticles immersed in a black dye. When an electric field is applied, the white nanoparticles of each pixel will migrate to either of the electrodes. Thus, when a negative electric field is applied, the white nanoparticles place themselves at one end of the pixel, revealing their white color or the color of the black dye depending on their position relative to the surface of the display. Consequently, by placing millions of pixels in the cavity of the display and by controlling them with electric fields, by means of an electronic circuit intended to manage the displaying of the information, it is possible to generate a two-color image. One of the advantages of this type of display is that the contrast obtained depends directly on the migration of the nanoparticles and on the color thereof. Furthermore, the display obtained is bistable since the image remains in place even once the electric field has been turned off. Such displays are based on EPIDS technology, in particular envisioned for equipping cell phones, electronic tablets, electronic books or else on-board displays on chip cards for example.

Regarding the nanoparticles, they are synthesized from an inorganic pigment which is encapsulated in, or which covers, an electrostatically chargeable polymer. The colloidal synthesis of these composite nanoparticles, comprising inorganic materials combined with polymers, gives rise to a great deal of interest by virtue of the variety of their applications. Nanoparticles of this type can in fact be used in photovoltaic cells, in medical imaging, or else in inks for example. The properties of such nanoparticles are thus very numerous owing to the various combinations, to the nature of the inorganic/organic materials, and also to the structure that they can adopt, such as a core-shell structure, or multilayer structure, or raspberry-like structure, or multipodal structure, for example. There are many routes for encapsulating inorganic particles, and each have their own characteristics.

One very widely used encapsulation method is the emulsion in its conventional form, and also in its declinations, such as the miniemulsion or the inverse emulsion, for example. When focusing on the pigments, the reference inorganic compound is titanium dioxide TiO₂. In the article entitled “Synthesis and characterization of titania coated polystyrene core-shell spheres for electronic ink”, published in the review journal Metals, 2005-152 (1-3), p. 9-12, I. B. Jang et al describe the synthesis of composite microparticles of polystyrene—TiO₂ in a polystyrene emulsion. The encapsulation of TiO₂ can also be carried out by emulsion in methyl methacrylate, but also in monomers which introduce surface functionalities, for instance poly(acrylic acid), or else poly(4-vinylpyridine). M. Balida et al. have, moreover, described the encapsulation of TiO₂ in poly(4-vinylpyridine) cationic microparticles in the article entitled “Encapsulation of TiO₂ in poly(4-vinylpyridine)-based cationic microparticles for electrophoretic inks” published in the journal Polymer, 2008, 49(21) p. 4529-4533. Particles of core-shell type are obtained by means of these methods. These particles are stable in aqueous media, and charged surfactants are used as electrostatic stabilizer, such as the surfactant SDS (sodium dodecyl sulfate). The dispersant medium of the final electrophoretic ink, produced on the basis of these particles, is a nonpolar or sparingly polar organic media. However, such a surfactant used as electrostatic stabilizer is not suitable for dispersion in an organic medium, since, in this type of nonpolar or sparingly polar medium, such as an alkane or toluene for example, the electrostatic repulsions have little or no effect and the only means of stabilizing the particles in such a medium is to count on the steric aspect.

The stabilization of pigments can also be carried out by grafting or adsorption of polymeric or nonpolymeric surfactants, which provide the energy barriers sufficient to disperse the pigments. Thus, for example, in the article entitled “Synthesis and characterization of blue electronic ink microcapsules” Journal of Shenzhen University Science and Engineering, 2009, 26(3) p. 251-256, Z Ni et al. describe the preparation of electrophoretic inks based on phthalocyanine blue (BGS) stabilized with cetyltrimethylammonium bromide (CTAB) which is a cationic surfactant used as a stabilizer, and sorbitan monooleate (Span 80) which is an anionic surfactant used as an emulsifier. This method is easy to implement since it only requires mixing the pigment with the surfactants in the selected medium and sonicating if required. However, it has a large drawback since no polymer layer makes it possible to protect the pigment, in particular against aggregation or sedimentation.

Methods of encapsulation by precipitation polymerization or dispersion polymerization are also used. According to these methods, the polymer is formed in situ, in the presence of the pigment, and precipitates on the pigment when a certain chain length is reached. These polymerizations are generally carried out in a light alcoholic medium, such as ethanol, methanol or an ethanol/water mixture for example, and involve monomers such as styrene, methyl methacrylate (MMA) or acrylic acid. Werts et al., in their article entitled “Titanium dioxide-Polymer core-shell particles dispersion as electronic inks for electrophoretic displays”, Chemistry of Material, 2008, 20(4) p. 1292-1298, describe, for example, a method for encapsulating TiO₂ particles by precipitation polymerization of a nonfunctional polymer around the TiO₂ pigment. A functionality is then added to the polymer by introducing, by grafting, an acid group at the surface of the composite particle synthesized. These methods make it possible to obtain two main types of particle structures. The first particle type comprises a core of pigment and a shell of polymer, and the second particle type comprises a core of polymer on which a pigment precipitates, by hydrolysis of a pigment precursor, such as tetrabutyl titanate in the case of titanium dioxide TiO₂, for example.

The article entitled “Density compatibility of encapsulation of white inorganic TiO2 particles using dispersion polymerization technique for electrophoretic display”, published in 2004, in particular by M. Kim, is also known. This article describes the obtaining of particles in a light and polar organic medium (ethanol), and the encapsulation is carried out in two polymerization steps. It should be noted, moreover, that the stability of the particles is in this case provided by a nonreactive stabilizer (PVP) which is not going to have a covalent link with the surface of the particle.

The article entitled “Preparation and characterization core-shell particles and application for E-ink”, published in 2007, in particular by Jing Wang, is also known. This article again describes the obtaining of particles in a light and polar organic medium (ethanol), and the encapsulation described in this case uses exclusively neutral monomers (and appears to demonstrate that the particles are neutral after encapsulation). As previously, it should be noted that the stability of the particles is provided in this case by a nonreactive stabilizer (PVP) which is not going to have a covalent link with the surface of the particle.

Finally, the article entitled “Polymer modified hematite nanoparticles for electrophoretic display”, published in 2008, in particular by Mi Ah Lee, is known. The disclosure in this document is identical to the two previously mentioned, namely in particular that the obtaining of the particles is carried out in a light and polar organic medium (ethanol).

All the encapsulation techniques which have just been mentioned make it possible to obtain stable composite nanoparticles only in aqueous or light alcoholic media. If the particles must then be placed in an organic medium, such as a liquid paraffin or an alkane, as has to be the case for an electrophoretic ink, a problem of stabilization then arises. The solution, in this case, consists in carrying out an exchange of surfactants. This step is, however, very difficult to implement since there is a risk of the particles irreversibly aggregating. Furthermore, the majority of encapsulations are carried out with nonfunctional polymers, such as styrene, to which the desired functionality is added, afterwards, by means of surfactants or by grafting of acid or basic groups at the surface of the particles.

These nanoparticle syntheses are therefore relatively complex and expensive to implement. However, in a context favorable to the development of a display means based on EPIDS technology, improving the synthesis of nanoparticles becomes essential, so as to reduce the cost of the ink, but also in order to increase the performance level of the associated display devices, to further reduce their production costs and therefore to increase their competitiveness in the market.

The objective of the invention is therefore to remedy at least one of the drawbacks of the prior art. The invention is in particular aimed at making it possible to develop a process for encapsulation of pigments by electrostatically chargeable functional polymers, directly in a nonpolar organic medium, and making it possible to bring great stability to the particles.

For this effect, a subject of the invention is a process for encapsulating at least one inorganic pigment by dispersion polymerization in an organic medium, characterized in that it consists in:
dispersing said inorganic pigment in said organic medium,
synthesizing at least one stable polymer latex in said organic medium, said latex precipitating around said inorganic pigment in order to form a protective shell and to thus obtain a particle, said synthesis of the latex being carried out by polymerization, in said organic medium, of an electrostatically chargeable functional monomer, based on the use of a macroinitiator capable of stabilizing said particle obtained, and in that the synthesis of the latex is carried out by polymerization, in said organic medium, of an electrostatically chargeable functional monomer, based on the combined use of a macroinitiator capable of stabilizing said particle obtained, and of a co-initiator.

In the context of the present invention, the term “latex” signifies a dispersion, in a solvent, of particles partially or completely formed from polymer.

Thus, the synthesis of the latex and the encapsulation of the inorganic pigment by this same latex take place in the same organic medium. There is therefore no need to change medium after the synthesis of the latex and before the encapsulation, the particles are stable in the organic medium from one end to the other of the process. By virtue of this encapsulation process, the synthesis of the particles intended for the manufacturing of an electrophoretic ink is therefore greatly simplified since anything takes place in the same medium. The nonpolar organic medium in which the encapsulation of the inorganic pigments is carried out then constitutes the dispersant medium of the final electrophoretic ink, which can be used for electrophoretic display devices.

According to one embodiment, the synthesis of the latex is carried out by polymerization, in said organic medium, of an electrostatically chargeable functional monomer, using a macroinitiator.

The combined use of the macroinitiator and of the co-initiator makes it possible not only to stabilize the particles obtained, but also to control the size thereof, such that the size of the particles obtained is compatible with the targeted application of electrophoretic ink for an electrophoretic display device.

Advantageously, the organic medium has a polarity index of less than 3 and is chosen from the nonexhaustive list of the following solvents: toluene, an alkane (such as octane), or an isoparaffinic fluid.

The co-initiator is a polymerization initiator. The co-initiator used is preferably a polymerization initiator manufactured and sold by the company Arkema under the brand name “Blockbuilder”.

The macroinitiator is a copolymer synthesized from a monomer of acrylate type and said co-initiator. The monomer of acrylate type can, for example, be chosen from the following monomers: 2-ethylhexyl acrylate, octyl acrylate, lauryl acrylate and octadecyl acrylate.

The macroinitiator/co-initiator molar ratio used is advantageously between 0.5 and 40. It is preferably between 2.5 and 30. Such a ratio makes it possible to obtain particles having a size of between 0.5 and 2 μm. Advantageously, the combined use of a co-initiator and of a macroinitiator, in these proportions, makes it possible to control the size of the particles obtained since the size of the latex particles varies according to the amounts of macroinitiator and of co-initiator, at fixed amount of monomer. The pigment thus encapsulated in the protective polymer shell forms a particle. The electrostatically chargeable functional monomer is chosen from: 4-vinylpyridine, dimethylamino methacrylate, or any other monomer which has a chargeable amine group with a pKa greater than 5 (pKa is the acidity constant, well known to those skilled in the art), so as to be able to positively charge said particle, and, furthermore, an acrylic or methacrylic acid or derivatives thereof which may or may not be copolymerized with another neutral monomer chosen from styrene or methyl methacrylate, so as to be able to negatively charge this particle.

By virtue of the combined use of the co-initiator and of the macroinitiator, the monomer will polymerize and, when polymerizing, it precipitates on the particles of pigment in dispersion. The polymer shell thus formed protects the pigment against aggregation and sedimentation. This shell gives the final particle the ability to become charged since it consists of functional polymers, i.e. of polymers comprising acidic or basic groups capable of receiving a charge. Thus, for example, 4-vinylpyridine is known to be a basic compound. Consequently, the functional polymer formed from 4-vinylpyridine, placed in the presence of iodomethane for example, will capture the methyl group, quaternizing its nitrogen atom, and will become positively charged. Another way to charge the functional polymers consists simply in bringing the basic and acidic units of the polymer shells into contact in order to exchange protons and to reveal charges. Thus, for example, a basic polymer comprising, for example, a nitrogen atom, in the presence of an acidic molecule such as hydrochloric acid for example, will gain a proton which attaches to the nitrogen atom via a covalent bond, quaternizing it, and will thus become positively charged.

The combined use of the macroinitiator and of the co-initiator in a macroinitiator/co-initiator molar ratio ranging from 0.5 to 40 makes it possible to obtain particles having sizes of between 50 nm and 50 μm. When this ratio is preferably between 2.5 and 30, the particles obtained have a size of between 0.5 and 2 μm.

Prior to its dispersion, the inorganic pigment is subjected to a surface treatment, so as to increase its hydrophobicity, and it is then dispersed in the organic medium by means of ultrasound. This surface treatment can, for example, consist of the grafting of carbon-based chains onto the hydroxyl groups of the pigment in order to increase its hydrophobicity. Once the surface modification has been carried out, ultrasound is used to disperse the pigment.

According to one embodiment variant, prior to its dispersion, the inorganic pigment is mixed with a surfactant, so as to modify its surface tension. The inorganic pigment is then dispersed in the nonpolar organic medium by means of ultrasound. The surfactant used is, for example, sorbitan monooleate (Span 80).

The organic medium has a polarity index of less than 3 and is chosen from the nonexhaustive list of the following solvents: toluene, an alkane, or an isoparaffinic fluid.

The invention also relates to the use of such an encapsulation process for the manufacture of an electrophoretic ink comprising positively charged particles containing a first pigment and negatively charged particles containing a second pigment, said positively and negatively charged particles being synthesized separately in the same nonpolar organic medium and then mixed, said nonpolar organic medium constituting the dispersant medium of said electrophoretic ink.

Finally, the invention relates to an electrophoretic ink comprising two types of particles, a first type being positively charged and containing a first pigment, a second type being negatively charged and containing a second pigment, said electrophoretic ink being characterized in that it comprises a dispersant medium which is identical to or compatible with the nonpolar organic medium in which each particle type is synthesized according to the abovementioned encapsulation process.

For the aforementioned and in the remainder of the description:
the tem “co-initiator” or “initiator” denotes without distinction an additive used to initiate a polymerization reaction. After the initiator of the polymerization reaction, the co-initiator forms a homopolymer which, by virtue of its precipitation, will be the beginning of the particles and will be responsible for their growth. Throughout the remainder of the description, the co-initiator used is an initiator manufactured and sold by the company Arkema under the brand name “Blockbuilder”;
and the term “macroinitiator” denotes an additive composed of a hydrophobic polymer chain, which serves to stabilize the particles, and of an initiator part which serves to initiate the polymerization reaction and results, in the end, in the formation of a copolymer. In the remainder of the description, in order to clearly differentiate the hydrophobic polymer chain serving to stabilize the particles, it is denoted by the term “steric repulsion hair”. The macroinitiator is advantageously synthesized from the co-initiator. Consequently, the initiator part of the macroinitiator is identical to the co-initiator. The macroinitiator and the co-initiator both initiate in parallel the polymerization reaction of a functional monomer. At the end of the polymerization reaction, a copolymer is formed which comprises a newly formed polymer chain at the end of the steric repulsion hair and which is anchored in the particle. Thus, the steric repulsion hair, remains attached to the particle and can thus stabilize it in the nonpolar organic medium.

The co-initiator, itself, serves just to initiate the reaction and produces only a homopolymer. The combination of these two initiators in appropriate proportions makes it possible to precisely control the size of the latex particles that will be obtained at the end. Indeed, the proportion between the two types of initiators will influence the homopolymer-to-copolymer ratio and thus the size of the particles obtained.

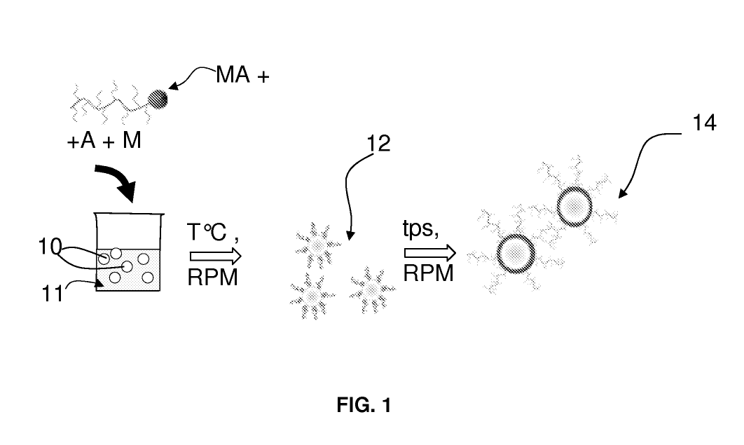

Other advantages and features of the invention will emerge on reading the following examples given by way of illustrating and nonlimiting example, with reference to FIG. 1 which represents a scheme of the principle of the steps of the encapsulation process according to the invention.

FIG. 1 shows a scheme of the principle of the encapsulation process according to the invention. This process makes it possible to encapsulate particles of inorganic pigment with chargeable functional polymers which precipitate directly on the particles in one and the same nonpolar, or at the very least very sparingly polar, organic medium. Preferably, this nonpolar organic medium is chosen from solvents such as toluene, or an alkane, for instance octane. This solvent advantageously constitutes the dispersant medium of the final ink or, at the very least, it is compatible therewith. The final ink can thus be produced by simple mixing of at least two organic dispersions, each containing a different pigment, the pigments of each dispersion being encapsulated respectively in polymers of opposite charges.

During the dispersion polymerization, the chargeable monomers are still soluble in the organic phases, whereas the corresponding polyamines are not.

The pigment, referenced 10 in FIG. 1, is quite simply dispersed in the organic medium, referenced 11 in FIG. 1, by virtue of a surface treatment or of a surfactant. The surface treatment can, for example consist of the grafting of carbon-based chains onto the hydroxyl groups of the pigment in order to increase its hydrophobicity. Once the surface modification has been carried out, ultrasound is used to disperse the pigment.

According to one embodiment variant, a surfactant, such as sorbitan monooleate (Span 80), is used so as to modify the surface tension of the pigment. The inorganic pigment is then dispersed in the nonpolar organic medium by means of ultrasound.

Next, a polymerization reaction is carried out such that the polymer synthesized precipitates at the surface of the inorganic pigment so as to produce a polymer shell which will protect it against aggregation and sedimentation, will stabilize it and will give it the ability to become charged in a nonpolar organic medium.

In order for the chargeable functional polymer to be able to precipitate around the pigment and to form the protective shell, the combined use of a co-initiator and of a macroinitiator makes it possible not only to initiate this polymerization reaction, but also to bring great stability to the particles thus synthesized, and to very precisely control the size thereof. This step of polymerization of a monomer, referenced M in FIG. 1, by precipitation on the pigment, is advantageously carried out in the presence of a co-initiator, referenced A in FIG. 1, and of a macroinitiator referenced MA in FIG. 1. The macroinitiator MA is represented schematically by a circle corresponding to the charged part of the polymerization initiation, and by a chain which is connected thereto and which corresponds to the polymer chain which serves to sterically stabilize the particles, also called steric repulsion hair.

The macroinitiator MA is advantageously synthesized from the co-initiator A and from a monomer of acrylate type, such as 2-ethylhexyl acrylate, octyl acrylate, lauryl acrylate or octadecyl acrylate, for example. Furthermore, the addition of a co-initiator A as a supplement to the macroinitiator MA, in appropriate proportions, makes it possible to very precisely control the size of the particles formed.

When the monomer M, the macroinitiator MA and the co-initiator A are added to the organic medium 11 containing the pigments in dispersion 10, the solution is heated to a temperature of, for example, between 100 and 130° C., preferably 120° C., and stirred at 300 revolutions per minute (RPM). Particles 12 then begin to form at the surface of the pigments. The solution is kept stirring for a period of between 6 and 12 h. After this period, particles 14 of core-shell type, which are stable in organic medium, are obtained; more specifically, the particles obtained belong to the subcategory of particles of “raspberry” type.

The protective polymer shells thus formed around the pigments are synthesized from functional monomers. The functional monomers are chosen according to the final charge that the particle will have to carry. Thus, in order to have positively charged particles for example, the functional polymer covering pigments is formed from monomers of 4-vinylpyridine, or dimethylamino methacrylate-co-styrene for example. In order to have negatively charged particles, the functional polymer covering the pigments is formed from an acrylic or methacrylic acid, and derivatives thereof, which may or may not be copolymerized with another neutral monomer such as styrene or MMA (methyl methacrylate).

There is only one type of polymer shell per pigment. Thus, for example, red particles have negative shells, whereas white particles have positive shells. A white particle cannot have a positive shell and at the same time a negative shell.

### EXAMPLE 1

### Synthesis of a Positively Charged White Particle

The products used for this synthesis are the following: a white pigment of titanium dioxide TiO₂, Span 80 (sobitan monooleate), as surfactant to allow good dispersion of the pigment particles in the nonpolar solvent, the co-initiator sold by the company Arkema under the brand name “Blockbuilder”, 2-ethylhexyl acrylate intended to be used for the synthesis of the macroinitiator, 4-vinylpyridine which is the monomer intended to form the positively charged polymer shell encapsulating the white pigment, and toluene as nonpolar solvent. The 2-ethylhexyl acrylate and 4-vinylpyridine monomers are purified beforehand on a drying agent, such as calcium hydride CaH₂, and distilled under reduced pressure in order to remove any residual inhibitor.

1st Step: Synthesis of the Macroinitiator:

1.33 g of co-initiator and 26.10 g of 2-ethylhexyl acrylate are mixed in 30 ml of toluene, in a 100 ml round-bottomed flask. The solution is filled until it is homogenous. Vacuum/nitrogen cycles are then carried out with stirring in order to remove all the dissolved gases. The round-bottomed flask is then heated at 120° C. for 2 h with stirring and is then cooled in a bath of cold water. The macroinitiator thus formed is precipitated from methanol in order to purify it from the remaining monomer. The viscous liquid obtained is then dried under vacuum at 50° C. in order to remove the remaining solvent. The macroinitiator thus synthesized is ready to be used for the subsequent pigment encapsulation step.

2nd Step: Encapsulation of the TiO₂ Pigment by Dispersion Polmerization

3 g of TiO₂ and 4 g of Span 80 (sorbitan monooleate) are mixed in 200 ml of toluene, in a 250 ml beaker. Span 80 is the surfactant which enables better dispersion of the pigment particles in the nonpolar organic solvent. The solution is stirred for approximately 5 min until complete dissolution of the Span 80, and then the mixture is subjected to ultrasound in order to well disperse the pigment particles. For this, use is made of an ultrasound probe of which the power is adjusted to approximately 420W for 8 min, with alternation of a 2 s pulse and 2 s resting. During this sonication, the beaker containing the suspension is placed in a bath of cold water in order to prevent the temperature of the organic medium from increasing.

At the same time, 0.2 g of macroinitiator and 0.5 mg of co-initiator are dissolved in 5 ml of toluene. 5 ml of 4 vinylpyridine to be added are also prepared. As soon as the sonication is finished, the dispersion of TiO₂ is immediately poured into a 250 ml reactor with mechanical stirring at 300 revolutions per minute. The mixture of macroinitiator and co-initiator dissolved in toluene, and then the 4-vinylpyridine, are then added to the reactor and the whole mixture is heated at 120° C. for 12 h under nitrogen sweeping. The 4-vinylpyridine is the monomer that will form the polymer shell around the pigment and that it will subsequently be possible to positively charge.

The white particles thus synthesized are then recovered and are then purified by centrifugation/redispersion at 3000 revolutions per minute in toluene. This centrifugation step makes it possible to retain only particles of homogenous size. Another way to recover particles of homogenous size consists in performing a dialysis.

The white particles synthesized in the manner described in the exemplary embodiment are then positively charged in the presence of iodomethane for example. They are then mixed with a second population of particles of a different color and of opposite charge in order to form a two-color electrophoretic ink.

The example which has just been described for a white particle is valid for any pigment. Thus, among the pigments used for the various colors, use may, for example, be made of:
for red, hematite or cadmium red,
for green, cobalt green or chromium oxide,
for blue, copper silicate or cobalt blue,
for black, carbon black or magnetite.

This list of pigments is not exhaustive and any inorganic pigment (oxide, silicate, etc.) can be used provided that it has the colors selected for producing a given ink.

### EXAMPLE 2

### Influence of the Amount of Co-Initiator and of Macroinitiator on the Size of the Particles Obtained

For the targeted application of electrophoretic ink for an electrophoretic display device, the size of the particles of encapsulated pigment may be between 50 nm and 50 μm. Below 50 nm, there is a risk of having polymer chains which are too short and which will not precipitate and therefore will not form particles.

The size of the particles, for the targeted application, is preferably between 0.5 and 2 μm.

Advantageously, the choice of the size is obtained by varying the percentage of co-initiator relative to the percentage of macroinitiator at a fixed amount of monomer. In practice, when increasing the amount of co-initiator relative to the amount of macroinitiator, the size of the particles is increased, and vice versa. The table below gives the molar concentrations respectively of macroinitiator and co-initiator, expressed in mol.l⁻¹, and also the size of the particles obtained for each of these concentrations.

| Macroinitiator (mol · l⁻¹) | Co-initiator (mol · l⁻¹) | Particle size (nm) |
|---|---|---|
| 3.45 · 10⁻⁵ | 0 | 75 |
| 3.45 · 10⁻⁵ | 1.31 · 10⁻⁶ | 120 |
| 3.45 · 10⁻⁵ | 4.46 · 10⁻⁶ | 970 |
| 3.45 · 10⁻⁵ | 6.24 · 10⁻⁶ | 2100 |

The process for encapsulating pigments which has just been described makes it possible to greatly simplify the synthesis of electrophoretic inks, since all the steps of the process take place in the same nonpolar organic medium. The synthesis of the ink is therefore much faster to carry out and requires no difficult step risking in particular aggregation of the particles.

The synthesis of the ink consists in separately encapsulating each pigment of a color in a polymer shell which is respectively positively and negatively chargeable and then in mixing the two types of particles in the same nonpolar medium as that which was used for the synthesis thereof. The particles are therefore already stable in the dispersant medium of the ink, which can be used for display devices. There is therefore no additional step to be carried out in order to make these particles stable in the dispersant medium of the ink.

1. A process for encapsulating at least one inorganic pigment by dispersion polymerization in an organic medium, wherein the process consists of:
dispersing said inorganic pigment in said organic medium,
synthesizing at least one stable polymer latex in said organic medium, said latex precipitating around said inorganic pigment in order to form a protective shell and to thus obtain a particle, said synthesis of the latex being carried out by polymerization, in said organic medium, of an electrostatically chargeable functional monomer, based on the use of a macroinitiator capable of stabilizing said particle obtained,
and wherein the synthesis of the latex is carried out by polymerization, in said organic medium, of an electrostatically chargeable functional monomer, based on the combined use of a macroinitiator capable of stabilizing said particle obtained, and of a co-initiator.

2. The process as claimed in claim 1, wherein the synthesis of the latex is carried out by polymerization, in said organic medium, of an electrostatically chargeable functional monomer, using a macroinitiator.

3. The encapsulation process as claimed in claim 1, wherein the macroinitiator is a copolymer synthesized from a monomer of acrylate type and from said co-initiator.

4. The process as claimed in claim 1, wherein the macroinitiator/co-initiator molar ratio is between 0.5 and 40, and preferably between 2.5 and 30.

5. The encapsulation process as claimed in claim 1, wherein the combined use of the macroinitiator and of the co-initiator makes it possible to synthesize particles having sizes of between 50 nm and 50 μm.

6. The encapsulation process as claimed in claim 1, wherein the pigment encapsulated in said protective shell forms a particle and in that the electrostatically chargeable functional monomer is chosen from:
4-vinylpyridine, dimethylamino methacrylate, or any other monomer which has a chargeable amine group with a pKa greater than 5, in order to be able to positively charge said particle, and, furthermore,
an acrylic or methacrylic acid or derivatives thereof, which may or may not be copolymerized with another neutral monomer chosen from styrene or methyl methacrylate, in order to be able to negatively charge said particle.

7. The encapsulation process as claimed in claim 1, wherein the organic medium has a polarity index of less than 3 and is chosen from the nonexhaustive list of the following solvents: toluene, an alkane, or an isoparaffinic fluid.

8. The encapsulation process as claimed in claim 1, wherein, prior to its dispersion, said inorganic pigment is subjected to a surface treatment, so as to increase its hydrophobicity, and said inorganic pigment is then dispersed in the organic medium by means of ultrasound.

9. The encapsulation process as claimed in claim 1, wherein prior to its dispersion, said inorganic pigment is mixed with a surfactant, so as to modify its surface tension, and said inorganic pigment is then dispersed in the organic medium by means of ultrasound.

10. The use of the encapsulation process as claimed in claim 1, for manufacturing an electrophoretic ink comprising positively charged particles containing a first pigment and negatively charged particles containing a second pigment, said positively and negatively charged particles being synthesized separately in a nonpolar organic medium and then mixed, said nonpolar organic medium constituting the dispersant medium of said electrophoretic ink.

11. An electrophoretic ink comprising two types of particles, a first type being positively charged and containing a first pigment, a second type being negatively charged and containing a second pigment, said electrophoretic ink being characterized in that it comprises a dispersant medium which is identical to or compatible with the nonpolar organic medium in which each particle type is synthesized in accordance with the encapsulation process as claimed in claim 1.
